(19) United States
(12) Patent Application Publication
(10) Pub. No.: US 2004/0127274 A1
(43) Pub. Date: Jul. 1, 2004

(54) Card game method having three hands

(76) Inventor: Tom Franklin, Gulfport, MS (US)

Correspondence Address: Anderson & Morishita, L.L.C., Suite 102, 2725 S. Jones Blvd., Las Vegas, NV, 89146, US

(21) Appl. No.: 10/694,657

(22) Filed: Oct. 27, 2003

Related U.S. Application Data
(60) Provisional application No. 60/422,343, filed on Oct. 29, 2002.

(51) Int. Cl. A63F 13/00

(52) U.S. Cl. 463/11

(57) ABSTRACT

A three-hand Poker game method and device are set forth where the player makes a wager and the player and dealer are dealt cards to be arranged into a low ranked hand, a middle ranked hand and a high ranked hand and where the hands have a number of cards N determined by the following Low Hand N≧1, middle Hand N≧Number of cards for Hand 1 and High Hand N>Number of cards for Hand 2. The corresponding player and dealer hands are compared and if two out of the three hands outrank the dealer, the player wins their wager.

### CROSS-REFERENCE TO RELATED APPLICATION

This application is a utility conversion application of prior filed, provisional patent application Ser. No. 60/422,343 file Oct. 29, 2002 and titled “Card Game Method Having Three Hands ”.

### FIELD OF THE INVENTION

The present invention relates to methods for playing Poker-type card games.

### BACKGROUND

Poker games using playing cards are popular and well known. In most of the live table games, the play includes using five or more playing cards to from a hand. In player—banked games, rounds of player wagering are provided to form a pot for the hand. The player(s) with the highest Poker ranked hands win the pot, less any commission for the house.

There are also house—banked Poker-type games such as the poker game described in Suttle et al, U.S. Pat. No. 4,836,553 titled “POKER GAME ” the disclosure of which is incorporated by reference. This game also provides for a jackpot side wager and payment of jackpots for certain player Poker ranked holdings.

Another game is known as Pai Gow Poker played in many casinos and card clubs. To play the game the players each make a wager to play a hand. Seven cards are dealt to each player and the dealer. From the seven cards, each player makes a two card low hand and a five card high hand. The high hand must have a Poker ranking higher than that of the low hand. In my patent JACKPOT PAI GOW POKER, U.S. Pat. No. 5,584,486 issued Dec. 17, 1996, the disclosure of which is hereby incorporated by reference, the game of Pai Gow Poker is described.

In U.S. Pat. No. 6,155,568 issued to me and the disclosure of which is hereby incorporated by reference, I set forth a game akin to Pai Gow where dealer and each of players, from seven cards, assembles three hands, a two card low hand, a two card middle hand and a three card high hand, based upon the ranking of Poker hands.

It has also been known to convert traditionally live Poker games into electronic games. For example, it has been known to provide an electronic version of the poker game of Suttle et al identified above.

### BRIEF DESCRIPTION OF THE DRAWINGS

FIG. 1 shows a layout for live play of the game according to the method of the present invention; and

FIG. 2 shows a device fo electronic play of the game according to the present invention.

### DESCRIPTION

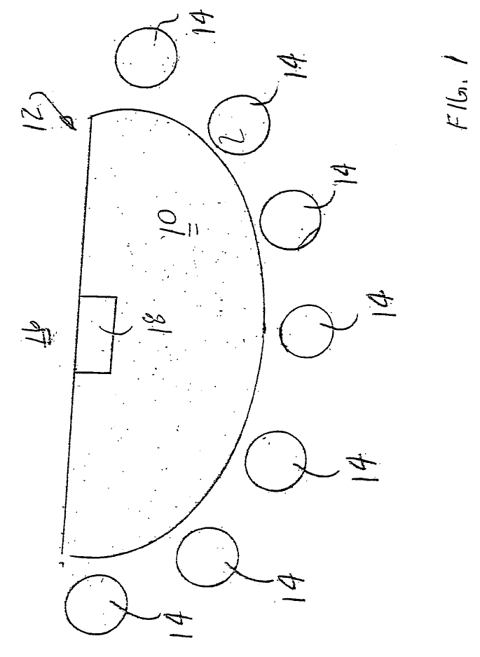

Turning to the drawings, at FIG. 1 there is shown a layout 10 for a gaming table 12 for the play of the game method of the present invention in a live game format. Disposed about the layout 10 are a number of player positions 14 to be occupied by players. Opposite the player positions 14 is a dealer position 16. Proximate the dealer position 16 is a chip tray 18 to hold chips exchanged between the dealer and player during the play of the game.

To play the game, at least one deck of at least fifty-two cards. Each player participating in the game makes a wager by placing the desired wager, as is known in the art, on the layout at their respective player position 14. After all participating players have made their wager, the dealer deals playing cards (face up or face down) to each participating player sufficient for the player to assemble at least three hands, a low hand, a middle hand and a high hand. The low hand includes at least one card, with each other hand including at least one card, e.g. a one card low hand, a two card middle hand and a three card high hand. Thus, each hand of the game may be represented by the following expression:

| Hand | Number of Cards |
|---|---|
| 1 | N (where N ≧ 1) |
| 2 | ≧N for Hand 1 |
| 3 | ≧N of Hand 2 |

In a preferred embodiment the number of cards for the hands is according to the following:

| Hand | Number of Cards |
|---|---|
| 1 | N (where N ≧ 1). |
| 2 | N + at least 1 |
| 3 | T − [Sum of cards of Hands 1 and 2] |

where T = the total number of the cards to be dealt.

Thus, for example where a total T of six cards are to be dealt and where Hand 1 has 1 card and Hand 2 has 2 cards. the hands, when assembled and displayed on the layout 10 at the player position 16, would appear as a triangle or pyramid. Below is an example of a player hand where N=1 and six cards are dealt to each player:

| | | | | | |
|---|---|---|---|---|---|
| Low Hand | | | 5⋄ | | |
| Middle Hand | | 7 [symbol] | | 7 [symbol] | |
| High Hand | J [symbol] | | J⋄ | | 4 [symbol] |

A like number of cards are dealt to the dealer position and the dealer forms his/her three hands according to the game rules, i.e. the middle hand must, according to the ranking of hands/cards of Poker, must outrank the low and the high hand must, in turn outrank the middle hand. In other words, from the low hand to the high hand, the rankings of the hands must be ascending or equal, according to the ranking of hands of Poker. Than is;

Hand 1≦Hand 2≦Hand 3

The dealer's cards are placed on the layout 10 in front of the tray 18. Each player then arranges their cards in the manner described above. In assessing the rankings of hands according to the method of the present invention, the standard Poker rankings are used except that straights or flushes are not considered for the ranking of the low and middle hands. Thus the hierarchy of rankings according to the present invention are as shown in Table 1 below.

TABLE 1

| Low Hand | Middle Hand | High Hand |
|---|---|---|
| Card Value, | Pair | Three card Royal Flush |
| Ace high | Card Values, Ace high | Straight flush |
| | | Three of a kind |
| | | Straight |
| | | Flush |
| | | Pair |
| | | Card Values, Ace high |

The player must set the hands according to their rankings as described above. If the player has mis-set the hand and it is a loser.

After each player has arranged their ands, the dealer exposes their cards and arranges his cards into a corresponding low, middle and high hand. The dealer may be required to set his hands according to a predetermined strategy.

After the players' and dealer's hands have been set the dealer compares, with each player, his low, middle and high hands to the corresponding player low, middle and high hands. If at least two of the player's three hands outrank the dealers corresponding hands, the player wins and is paid based upon their wager. If desired, a commission may be assessed for winning hands. If at least two of the dealer's three hands outrank the players corresponding hands, the dealer is declared the winner and the player's wager is lost and is collected by the dealer. If one or more of the player's hands has a tie ranking with the dealer, the tying hand(s) is/are deemed to outrank the corresponding player's hands.

After settling with each player, the dealer collects the cards of the hands. The players make new wagers and another hand is dealt.

In paying the players for winning hands, players are paid even money on their wager (less a commission if one is assessed).

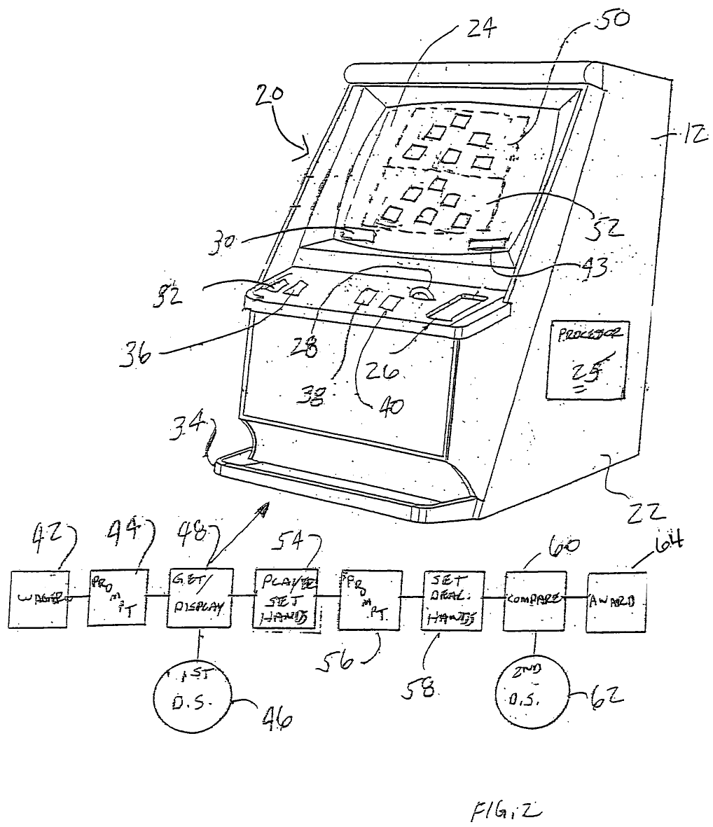

The game as described above can be embodied into an electronic device 20 as shown in FIG. 2. The device 12 has a housing 22 supporting a video display 24 and containing a game processor 25 configured to control play and the display 24 for the device 20 as hereinafter described.

The device 20 has apparatus for a player to make a wager. For example there may be a cash validator 26 and coin slot 28 to receive cash or tokens, respectively, for wagering. The deposited cash or tokens are converted by the processor 24 into gaming credits, the amount of which may be displayed at a credit meter 30 at the display 24.

The device 12 also includes a plurality of buttons for the player to control play of the game. At 32 is a cash out button which, if depressed by the player, prompts the processor 25 to dispense to the player the amount of the credit meter 30. The amount may be dispensed into a tray 34 as tokens or coins or may be dispensed as a ticket or voucher as is known in the art. At 36 is a bet one credit button whereby the player can wager less than a maximum amount for a hand of play. A maximum wager button 38 provides for the player to wager the maximum permitted by the device, e.g. ten credits. There is also a prompt button 40 for the player to prompt play and completion of the game as hereinafter described.

To play the device 12, at 42 the player enters the desired wager using the control buttons and at 44 prompts play. A bet meter 43 may be provided at the display 24 for the player to confirm the amount of the bet. When prompted the processor 25, accesses a first data structure 46 to at 48 randomly select and display at the display 24 the dealer's cards 50 (face down) and the players cards 52 face up. The player, using for example a touch screen display 24, mouse or other input device, sets their low hand, middle hand and high hand at 54 by arranging the cards in the manner described above. The processor 25 may preclude mis-setting of the player's hands 52 and may initially display the player's hands 52 in a suggested set for the player. After the player is satisfied with the setting of his hands 52, the processor 25 is prompted at 56 to complete play as by the player depressing the prompt button 40. The processor 25 sets and reveals the dealer's hands 50 at 58 according to a pre-programmed manner and at 60 compares the corresponding dealer low, middle and high hands to that of the player according to the predetermined ranking schedule which may be programmed or stored in a second data structure 62. If the player has won the hand, as described above by having higher ranking low and high hands, at 64 the processor 25 issues an award to the player, e.g. an even money payback.

The method of the present invention also embraces other hand arrangements. Depending upon the number of cards for the hands, the rankings would be as follows:

| | |
|---|---|
| 1 Card hands | Card Value, Ace high |
| 2 Card Hands | Pair (by card ranking) |
| | Card Value, Ace High |
| 3 Card Hands | Three card Royal Flush |
| | Straight flush |
| | Three of a kind |
| | Straight |
| | Flush |
| | Pair |
| | Card Values, Ace high |
| 4 cards | Four Card Royal Flush |
| | Straight flush |
| | Four of a Kind |
| | Three of a kind |
| | Straight |
| | Flush |
| | Pair |
| | Card Values, Ace high |
| 5 Cards | Traditional Poker ranking |

Thus, other three hand game arrangements according to the method may be as follows:

| | Example | | | | | | |
|---|---|---|---|---|---|---|---|
| | A | B | C | D | E | F | G |
| LowHand | 1 | 1 | 1 | 1 | 2 | 2 | 2 |
| Medium Hand | 1 | 1 | 2 | 3 | 2 | 2 | 3 |
| High Hand | 1 | 2 | 2 | 3 | 2 | 3 | 3 |

While I shown and described the game, it should be understood that it could be player as an Ace-low game, deuces wild, using a Joker to represent an Ace or as a low game where the player wins when his low and high hands are of a lower ranking

While I have shown and described certain embodiments of the present invention, it is to be understood that it is subject to many modifications without departing from the spirt and scope of the appended claims.

I claim:

1. A method for playing a card game by assembling at least three hands comprising:
the player making a wager;
dealing cards to a player position and dealer position sufficient for each to form at least a low hand, a middle hand and a high hand or one card each and where N=number of cards for each hand and hands have N cards according to the following expression;

| | |
|---|---|
| Hand 1 | N ≧ 1 |
| Hand 2 | ≧Number of cards for Hand 1 |
| Hand 3 | ≧Number of cards for Hand 2 |

the player and dealer assembling said low, middle and high hands such that the middle hand outranks the low hand and the high hand outranks the middle hand;
comparing the corresponding dealer and player low hands, middle hands, and high hands and if the at least two of the player's hands outrank the corresponding two dealer hands, issuing an award to the player.

2. The method of claim 1 comprising dealing cards to the player and dealer to form said low, middle and high hands according to the following formula,

| Hand | Number of Cards |
|---|---|
| 1 | N (where N ≧ 1) |
| 2 | >Number of Cards of Hand |
| 3 | ≧Number of cards for Hand 2. |

3. The method of claim 2 comprising dealing six cards to the dealer and player and each forming a one card low hand, a two card middle hand and a three card high hand.

4. The method of any one of the preceding claims comprising ranking the hands according to the rankings of Poker.

5. A device for playing a Poker game using comprising:
a device for the player to input a wager;
a display;
a data processor configured to randomly select from a data structure storing data representing a deck of playing cards, playing cards for each of a dealer hand and a player hand and to display at the display the cards of the player hand;
an input device for the player to input control to the processor to arrange at the display the player cards into a low ranked hand, a middle ranked hand and a higher ranked, where the number of cards for the hands are determined by

| | |
|---|---|
| Hand 1 | N ≧ 1 |
| Hand 2 | ≧Number of cards for Hand 1 |
| Hand 3 | ≧Number of cards for Hand 2 |

where N=the number of cards;
a prompting device for the player to prompt the processor to complete play, said processor configured to, upon the input of the prompt, arrange and display the dealer's hand into a corresponding low ranked hand, a middle ranked hand and a higher ranked hand according to the rules of Poker and said processor configured to compare the rankings of the corresponding player and dealer low, middle and high hands and (a) if at least two of the player's hands outrank the corresponding dealer's hands issuing an award to the player.
